(19) United States
(12) Patent Application Publication
(10) Pub. No.: US 2002/0016276 A1
(43) Pub. Date: Feb. 7, 2002

(54) Yarn strength enhancing agents and compositions and methods employing same

(75) Inventor: Wolfgang Ulrich Spendel, Cincinnati, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/837,982

(22) Filed: Apr. 19, 2001

Related U.S. Application Data
(60) Provisional application No. 60/198,702, filed on Apr. 20, 2000.

(51) Int. Cl. C11D 17/00

(52) U.S. Cl. 510/276; 510/473; 510/474; 510/507; 510/499

(57) ABSTRACT

The present invention relates to yarn strength enhancing agents, preferably suitable for use in laundry and/or fabric care compositions and/or laundry and/or fabric care methods/processes, and more particularly, the present invention relates to products, compositions, preferably laundry and/or fabric care compositions containing such yarn strength enhancing agents and laundry and/or fabric care methods/processes employing such materials.

### CROSS REFERENCE TO RELATED APPLICATIONS

This application claims priority under 37 U.S.C. §119(e) to U.S. Provisional Application Serial No. 60/198,702, filed Apr. 20, 2000 (Attorney Docket No. 8046P).

### FIELD OF THE INVENTION

The present invention relates to yarn strength enhancing agents, preferably suitable for use in laundry and/or fabric care compositions and/or laundry and/or fabric care methods/processes, preferably in-home laundering and/or laundry and/or fabric care methods/processes for finished garments, and more particularly, the present invention relates to products, compositions, preferably laundry and/or fabric care compositions containing such yarn strength enhancing agents and laundry and/or fabric care processes employing such materials.

### BACKGROUND OF THE INVENTION

In general, consumers desire to increase and/or enhance the wearable life of clothing and/or other garment articles.

Conventional laundering and fabric care processes clean and/or condition clothing and/or other garment articles at the expense of the tensile strength of the fibers comprising the clothing and/or other garment articles. This is especially true for clothing and/or other garment articles that are worn frequently by consumers and are laundered and/or treated in laundering and fabric care processes repeatedly over the useful life of the clothing and/or other garment articles.

Accordingly, there is a continuing need to mitigate and/or inhibit and/or eliminate the damage, such as pilling, and “wear and tear” to clothing and other garment articles as a result of conventional laundering and fabric care processes which the clothing and other garment articles are subjected to during their useful life.

### SUMMARY OF THE INVENTION

The present invention fulfills the need described above. The present invention provides yarn strength enhancing agents which can be identified according to a screening method herein described, and more preferably, yarn strength enhancing agents suitable for use in laundry and/or fabric care compositions, laundry and/or fabric care compositions and/or products comprising same, and laundry and/or fabric care methods/processes employing same.

It has been found that the strengthening of yarn reduces pilling of a garment by retarding and/or inhibiting fiber migration from within the yarn to the surface of the yarn.

In one aspect of the present invention, a method for treating a fabric in need of treatment comprising contacting the fabric with a yarn strength enhancing agent that satisfies Test Protocol as described herein, is provided.

In another aspect of the present invention, a laundry and/or fabric care composition comprising a yarn strength enhancing agent that satisfies Test Protocol as described herein, is provided.

In still yet another aspect of the present invention, a product comprising a yarn strength enhancing agent that satisfies Test Protocol as described herein, is provided.

In yet another aspect of the present invention, a product comprising a yarn strength enhancing agent that satisfies Test Protocol as described herein, the product further including instructions for using the a yarn strength enhancing agent to treat a fabric in need of treatment, the instructions including the step of contacting the fabric with an amount of the product comprising the yarn strength enhancing agent, is provided.

All percentages, ratios and proportions herein are on a weight basis unless otherwise indicated. All documents cited herein are hereby incorporated by reference.

### DETAILED DESCRIPTION OF THE INVENTION

The screening method of the present invention is suitable for identifying yarn strength enhancing agents. Such yarn strength enhancing agents are preferably incorporated into laundry and/or fabric care compositions, products, and methods.

### Screening Methods

### Test Protocol

Whether an agent, other than a carboxymethylcellulose, an ethoxymethylcellulose, polyvinyl amines, polyimines and polyethoxylated imine agents, is a suitable yarn strength enhancing agent as defined herein is determined by the following Test Protocol. In other words, carboxymethylcellulose, ethoxymethylcellulose, polyvinyl amines, polyimines and polyethoxylated imine agents are not yarn strength enhancing agents as defined herein. However, they can be adjunct ingredients optionally present in any compositions of the present invention.

If the agent satisfies the following Test Protocol, then the agent is a yarn strength enhancing agent within the scope and for purposes of this invention.

Step 1: Obtain Yarn

A sufficient amount of 18/1 100% cotton open-end spun yarn, preferably greater than 202 feet, is obtained from Cotton Inc. The cotton open-end spun yarn is preferably completely or substantially unfinished yarn, for example unsized yarn.

Step 2: Preparation of Control Yarn

About 101 feet of the yarn (about 0.9447 grams; about 263 Denier), in other words, a length of yarn sufficient to provide 60-6 inch samples such that the samples can be held securely in straight discrete lengths and provide a 4 inch span, from Step 1 is submerged in 3 gallons of a 90° F. deionized water/detergent solution (Solution A) in a manner such that all or substantially all of the external surfaces of the yarn are in contact with Solution A. A yarn holder whereby the 101 feet of yarn is wrapped about the yarn holder in a manner such that substantially all of the external surfaces of the yarn are in contact with Solution A upon submersion may be used. The detergent solution consists of: 1) 200 ppm NEODOL® 23-9, commercially available from Shell Chemical Company; 2) 150 ppm sodium carbonate; and 100 ppm sodium citrate commercially available, for example, from Aldrich Chemical Company. The pH of Solution A is adjusted as needed with 5% sulfuric acid or 5% sodium hydroxide to achieve a pH of 10.

After submersion of the yarn sample into Solution A, Solution A is stirred for about one (1) hour at a rate that is sufficient to circulate the solution without distorting the yarn, preferably the a rate that provides maximum circulation without distorting the yarn. The yarn is then removed from Solution A immediately after stirring is complete. The yam is then rinsed for 2 minutes in 2 gallons of deionized water. The yarn is air dried. This yarn represents the Control Yarn.

Step 3: Preparation of Test Yarn

The remainder of the yarn from Step 1, about 101 feet of the yarn (approximately 263 Denier), is submerged in a mixture (Mixture ABC) of two solutions in a manner such that all or substantially all of the external surfaces of the yarn are in contact with Solution A. As indicated in Step 2 above, a yarn holder may be used to facilitate this submersion. The first solution is 3 gallons of a 90° F. deionized water/detergent solution (Solution A) wherein the detergent solution consists of: a) 200 ppm NEODOL® 23-9, commercially available from Shell Chemical Company; b) 150 ppm sodium carbonate; and c) 100 ppm sodium citrate, (identical to Step 2). The second solution is a 1% test material solution/dispersion in deionized water (Solution B). Solution B is stirred for a sufficient time to allow the test material to go into solution and/or hydrate (marginally soluble material) for up to thirty (30) minutes. Solution A and Solution B are then mixed together for two (2) minutes to form the mixture (Mixture AB). To Mixture AB, calcium and magnesium are added to achieve a Ca:Mg, 3:1 water hardness to make the resulting Mixture ABC 4 gr/gal (5.13×10⁴ Molar Ca⁺²: 1.71×10⁻⁴ Molar Mg⁺² added as chlorine salt). After adding the calcium and magnesium, Mixture ABC is then mixed for two (2) minutes.

Next, the pH of Mixture ABC is adjusted as needed using 5% sulfuric acid or 5% sodium hydroxide to achieve a pH of 10.

After the test yarn sample has been submerged in Mixture ABC, Mixture ABC is stirred for about one (1) hour at a rate that is sufficient to circulate the solution without distorting the yarn, preferably the a rate that provides maximum circulation without distorting the yarn. The yarn is then removed from Mixture ABC immediately after stirring is complete. The yarn is then rinsed for 2 minutes in 2 gallons of deionized water. The yarn is then air dried. This yarn represents the Test Yarn.

The level of Test Material present in Mixture ABC can be varied, for example 15 ppm, 60 ppm, and 200 ppm. In order to vary the level of Test Material in Mixture ABC, those of ordinary skill in the art will modify the preparations.

Step 4: Control Yarn Strength Measurement

A yarn strength measurement of the Control Yarn, as prepared according to Step 2 above, is obtained using an Instron pull rate method according to ASTM Method D2256-90 “Standard Test Method for Tensile Properties of Yarns by the Single Strand Method”.

Under the Instron pull rate method, the Control Yarn is conditioned for at least 6 hours at room temperature, about 70° F. (21° C.) and 65% relative humidity. A six inch length sample of the Control Yarn is cut from the about 101 feet of Control Yarn. The Instron gage length is set to 4 inches. The six inch length sample is pulled at a rate of 4.8 inches per minute with extension length sufficient to break yarn. The maximum tensile for the Control Yarn is recorded.

During the Instron pull rate method, six inch length yarn samples that break within 0.125 inch of the jaw grips are discarded.

Step 5: Test Yarn Strength Measurement

A yarn strength measurement of the Test Yarn, as prepared according to Step 3 above, is obtained using an Instron pull rate method according to ASTM Method D2256-90 “Standard Test Method for Tensile Properties of Yarns by the Single Strand Method”.

Under the Instron pull rate method, the Test Yarn is conditioned, contemporaneously with the conditioning of the Control Yarn according to Step 5, for at least 6 hours at room temperature, about 70° F. and 65% relative humidity. A six inch length sample of the Test Yarn is cut from the about 101 feet of Test Yarn. The Instron gage length is set to 4 inches. The six inch length sample is pulled at a rate of 4.8 inches per minute with extension length sufficient to break yarn. The maximum tensile for the Test Yarn is recorded.

During the Instron pull rate method, six inch length yarn samples that break within 0.125 inch of the jaw grips are discarded.

Step 6: Calculate Difference Between Test Yarn Maximum Tensile and Control Yarn Maximum Tensile

A Standard Student's t test for significant difference is used to distinguish the difference as a percent between Test Yarn Maximum Tensile and Control Yarn Maximum Tensile and then % change is determined. 60 test yarns are pulled prior to completing Step 6.

Step 7: Determination of whether Test Material is a Yarn strength enhancing agent

If the percent difference calculated from Step 6 above is as outlined below in the chart, then the Test Material or Agent is a Yarn strength enhancing agent within the scope of the present invention.

| Level of Test Material in Mixture ABC | Difference from Step 6 |
|---|---|
| 15 ppm | 3% or greater |
| 60 ppm | 3% or greater |
| 200 ppm | 5% or greater |

### Laundry and/or Fabric Care Compositions

The laundry and/or fabric care compositions of the present invention also comprise, in addition to one or more yarn strength enhancing agents of the present invention described herein before, one or more adjunct materials, preferably compatible with the yarn strength enhancing agent(s). The term “adjunct materials”, as used herein, means any liquid, solid or gaseous material selected for the particular type of laundry and/or fabric care composition desired and the form of the product (e.g., liquid; granule; powder; gel composition), which materials are also preferably compatible with the yarn strength enhancing agents of the present invention. Granular compositions can also be in “compact” form and the liquid compositions can also be in a “concentrated” form.

The specific selection of adjunct materials are readily made by considering the surface, item or fabric to be cleaned, and the desired form of the composition for the laundry and/or fabric care conditions during use (e.g., through the wash detergent use). Examples of suitable adjunct materials include, but are not limited to, surfactants, builders, bleaches, bleach activators, bleach catalysts, non-activated enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, hydrolyzable surfactants, perservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments and pH control agents as described in U.S. Pat. Nos. 5,705,464, 5,710,115, 5,698,504, 5,695,679, 5,686,014 and 5,646,101. Specific adjunct materials are exemplified in detail hereinafter.

Preferably an effective amount of one or more yarn strength enhancing agents described above are included in compositions useful for laundering a variety of fabrics in need of treatment.

As used herein, “effective amount of one or more yarn strength enhancing agents” refers to the quantity of yarn strength enhancing agents of the present invention described hereinbefore necessary to achieve the yam strength increase necessary in the specific laundry and/or fabric care composition. Such effective amounts are readily ascertained by one of ordinary skill in the art and is based on many factors, such as the particular yarn strength enhancing agent used, the laundry and/or fabric care application, the specific composition of the laundry and/or fabric care composition, and whether a liquid or dry (e.g., granular, powder) composition is required, and the like.

The laundry and/or fabric care compositions of the present invention comprise:

(a) one or more yarn strength enhancing agents in accordance with the present invention; and

(b) one or more adjunct materials.

Preferably, the laundry and/or fabric care compositions comprise from about 0.0001%, preferably from about 0.001%, more preferably from about 0.01% by weight of the laundry and/or fabric care compositions of one or more yarn strength enhancing agents of the present invention, to about 10%, preferably to about 2%, more preferably to about 1%, most preferably to about 0.1%.

Preferably, the laundry and/or fabric care compositions of the present invention comprise one or more yarn strength enhancing agents of the present invention such that the yarn strength enhancing agents are present in the laundry and/or fabric care compositions of the present invention at a level of from about 0.0001%, preferably from about 0.001%, more preferably from about 0.01% to about 10%, preferably to about 2%, more preferably to about 1%, most preferably to about 0.1% of yarn strength enhancing agent by weight of the laundry and/or fabric care composition.

Several examples of various laundry and/or fabric care compositions wherein the yarn strength enhancing agents of the present invention may be employed are discussed in further detail below. Also, the laundry and/or fabric care compositions may include from about 1% to about 99.9% by weight of the composition of the adjunct materials.

As used herein, “fabric laundry and/or fabric care compositions” include hand and machine laundry and/or fabric care compositions including laundry and/or fabric care additive compositions and compositions suitable for use in the soaking and/or pretreatment of stained fabrics. The fabric laundry and/or fabric care compositions and/or methods and/or processes of the present invention are preferably for in-home use and/or for use on finished garments.

When the laundry and/or fabric care compositions of the present invention are formulated as compositions suitable for use in a laundry and/or fabric care machine washing method, the compositions of the present invention preferably contain both a surfactant and a builder compound and additionally one or more adjunct materials preferably selected from organic polymeric compounds, bleaching agents, additional enzymes, suds suppressors, dispersants, lime-soap dispersants, soil suspension and anti-redeposition agents and corrosion inhibitors. Laundry and/or fabric care compositions can also contain softening agents, as additional adjunct materials.

The compositions of the present invention can also be used as detergent additive products in solid or liquid form. Such additive products are intended to supplement or boost the performance of conventional detergent compositions and can be added at any stage of the laundry and/or fabric care process.

If needed the density of the laundry and/or fabric care compositions herein ranges from 400 to 1200 g/liter, preferably 500 to 950 g/liter of composition measured at 20° C.

The “compact” form of the laundry and/or fabric care compositions herein is best reflected by density and, in terms of composition, by the amount of inorganic filler salt; inorganic filler salts are conventional ingredients of detergent compositions in powder form; in conventional detergent compositions, the filler salts are present in substantial amounts, typically 17-35% by weight of the total composition. In the compact compositions, the filler salt is present in amounts not exceeding 15% of the total composition, preferably not exceeding 10%, most preferably not exceeding 5% by weight of the composition. The inorganic filler salts, such as meant in the present compositions are selected from the alkali and alkaline-earth-metal salts of sulfates and chlorides. A preferred filler salt is sodium sulfate.

Liquid laundry and/or fabric care compositions according to the present invention can also be in a “concentrated form”, in such case, the liquid laundry and/or fabric care compositions according the present invention will contain a lower amount of water, compared to conventional liquid detergents. Typically the water content of the concentrated liquid laundry and/or fabric care composition is preferably less than 40%, more preferably less than 30%, most preferably less than 20% by weight of the laundry and/or fabric care composition.

### Adjunct Materials

While not essential for the purposes of the present invention, several conventional adjunct materials illustrated hereinafter are suitable for use in the laundry and/or fabric care compositions containing the irradiated enzymes of the present invention, and may be desirably incorporated in preferred embodiments of the invention, for example to assist or enhance cleaning performance, for treatment of the substrate to be cleaned, or to modify the aesthetics of the laundry and/or fabric care composition as is the case with perfumes, colorants, dyes or the like. The precise nature of these additional components, and levels of incorporation thereof, will depend on the physical form of the composition and the nature of the cleaning operation for which it is to be used. Unless otherwise indicated, the laundry and/or fabric care compositions of the invention may for example, be formulated in the form of a granular, powder, liquid, bar, paste, foam, tablet (including dimple tablet), and/or gel composition; heavy-duty detergent compositions, fine-fabric detergent compositions, fabric care composition, including rinse-added compositions, dryer-added compositions, car or carpet shampoos, as well as cleaning auxiliaries such as bleach additives and “stain-stick” or pre-treat types.

### Adjunct Materials

In addition to the yarn strength enhancing agent, one or more adjunct ingredients may optionally, but preferably, be included in the compositions, products and/or systems comprising the yarn strength enhancing agent.

Surfactants—A wide range of surfactants can be used in the compositions of the present invention.

Surfactants included in the fully-formulated compositions afforded by the present invention comprise at least 0.01%, preferably at least about 0.1%, more preferably at least about 0.5%, even more preferably at least about 1%, most preferably at least about 3% to about 80%, more preferably to about 60%, most preferably to about 50% by weight of composition depending upon the particular surfactants used and the desired effects to be achieved.

The surfactant can be nonionic, anionic, amphoteric, amphophilic, zwitterionic, cationic, semi-polar nonionic, and mixtures thereof, nonlimiting examples of which are disclosed in U.S. Pat. Nos. 5,707,950 and 5,576,282. A typical listing of anionic, nonionic, amphoteric and zwitterionic classes, and species of these surfactants, is given in U.S. Pat. No. 3,664,961 issued to Norris on May 23, 1972. Preferred compositions comprise nonionic surfactants and/or mixtures of nonionic surfactants with other surfactants, especially anionic surfactants.

Nonlimiting examples of surfactants useful herein include the conventional C₈-C₁₈ alkyl ethoxylates (“AE”), with EO about 1-22, including the so-called narrow peaked alkyl ethoxylates and C₆-C₁₂ alkyl phenol alkoxylates (especially ethoxylates and mixed ethoxy/propoxy), alkyl dialkyl amine oxide, alkanoyl glucose amide, C₁₁-C₁₈ alkyl benzene sulfonates and primary, secondary and random alkyl sulfates, the C₁₀-C₁₈ alkyl alkoxy sulfates, the C₁₀-C₁₈ alkyl polyglycosides and their corresponding sulfated polyglycosides, C₁₂-C₁₈ alpha-sulfonated fatty acid esters, C₁₂-C₁₈ alkyl and alkyl phenol alkoxylates (especially ethoxylates and mixed ethoxy/propoxy), C₁₂-C₁₈ betaines and sulfobetaines (“sultaines”), C₁₀-C₁₈ amine oxides, and the like. Other conventional useful surfactants are listed in standard texts.

Bleaching System—The compositions of the present invention may comprise a bleaching system. Bleaching systems typically comprise a “bleaching agent” (source of hydrogen peroxide) and an “initiator” or “catalyst”. Nonlimiting examples of bleaching systems are preformed peracids, metal-containing bleach catalysts and a source of hydrogen peroxide in conjunction with the bleach activator, such as NOBS. When present, bleaching agents will typically be at levels of from about 1%, preferably from about 5% to about 30%, preferably to about 20% by weight of the composition. If present, the amount of bleach activator will typically be from about 0.1%, preferably from about 0.5% to about 60%, preferably to about 40% by weight, of the bleaching composition comprising the bleaching agent-plus-bleach activator.

Enzymes—With respect to the enzymes in the particulate solid of the present invention, any suitable enzyme can be used. The preferred enzymes for use in the particulate solids of the present invention are selected from proteases, amylases, cellulases and mixtures thereof. Nonlimiting examples of other suitable enzymes include the following:

Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, βglucanases, arabinosidases, hyaluronidase, chondroitinase, laccase, mannanases, more preferably plant cell wall degrading enzymes and non-cell wall-degrading enzymes (WO 98/39403 A) and can, more specifically, include pectinase (WO 98/06808 A, JP10088472 A, JP10088485 A); pectolyase (WO98/06805 A1); pectin lyases free from other pectic enzymes (WO9806807 A1); chondriotinase (EP 747,469 A); xylanase (EP 709,452 A, WO 98/39404 A, WO98/39402 A) including those derived from microtetraspora flexuosa (U.S. Pat. No. 5,683,911); isopeptidase (WO 98/16604 A); keratinase (EP 747,470 A, WO 98/40473 A); lipase (GB 2,297,979 A; WO 96/16153 A; WO 96/12004 A; EP 698,659 A; WO 96/16154 A); cellulase or endoglucanase (GB 2,294,269 A; WO 96/27649 A; GB 2,303,147 A; WO98/03640 A; see also neutral or alkaline cellulases derived from chrysosporium lucknowense strain VKM F-3500D as disclosed in WO9815633 A); polygalacturonase (WO 98/06809 A); mycodextranase (WO 98/13457 A); thermitase (WO 96/28558 A); cholesterol esterase (WO 98 28394 A); or any combination thereof; and known amylases; oxidoreductases; oxidases or combination systems including same (DE19523389 A1); mutant blue copper oxidases (WO9709431 A1), peroxidases (see for example U.S. Pat. No. 5,605,832, WO97/31090 A1), mannanases (WO9711164, WO 99/09126, PCT/US00/00839); xyloglucanases (WO 98/50513, PCT/US/00/00839, WO 99/02663); laccases, see WO9838287 A1 or WO9838286 A1 or for example, those laccase variants having amino acid changes in myceliophthora or scytalidium laccase(s) as described in WO9827197 Al or mediated laccase systems as described in DE19612193 A1), or those derived from coprinus strains (see, for example WO9810060 A1 or WO9827198 A1), phenol oxidase or polyphenol oxidase (JP10174583 A) or mediated phenol oxidase systems (WO9711217 A); enhanced phenol oxidase systems (WO 9725468 A WO9725469 A); phenol oxidases fused to an amino acid sequence having a cellulose binding domain (WO9740127 A1, WO9740229 A1) or other phenol oxidases (WO9708325 A, WO9728257 A1) or superoxide dismutases. Oxidoreductases and/or their associated antibodies can be used, for example with H₂O₂, as taught in WO 98/07816 A. Depending on the type of composition, other redox-active enzymes can be used, even, for example, catalases (see, for example JP 09316490 A).

### METHODS OF THE PRESENT INVENTION

A method for treating a fabric in need of treatment comprising contacting the fabric with a yarn strength enhancing agent that satisfies the Test Proctol as described herein. Preferably the yarn strength enhancing agent is selected from the group consisting of: polysaccharides, clays, starches, polyvinyl amines, chitosans, and mixtures thereof.

### Yarn Strengthened Article

A yarn strengthened article results the methods of the present invention.

### Product/Instructions of Use

This invention also may encompass the inclusion of instructions on the use of the yarn strength enhancing agent-containing compositions described herein with the packages containing the yarn strength enhancing agent-containing compositions or with other forms of advertising associated with the sale or use of the yarn strength enhancing agent-containing compositions. The instructions may be included in any manner typically used by consumer product manufacturing or supply companies. Examples include providing instructions on a label attached to the container holding the system and/or composition; on a sheet either attached to the container or accompanying it when purchased; or in advertisements, demonstrations, and/or other written or oral instructions which may be connected to the purchase or use of the yam strength enhancing agent compositions.

Specifically the instructions will include a description of the use of the yarn strength enhancing agent compositions. The instructions, for instance, may additionally include information relating to the recommended amount of yarn strength enhancing agent compositions to apply to the article in need of treatment, if soaking or rubbing is appropriate to the article; the recommended amount of water, if any, to apply to the article before and after treatment; other recommended treatments.

The yarn strength enhancing agent compositions may be incorporated into a product, the product may be a kit comprising the yarn strength enhancing agent compositions. Accordingly, a product comprising a yarn strength enhancing agent composition of the present invention, the product further including instructions for using the yarn strength enhancing agent composition to treat an article, preferably a finished garment.

### The following examples are illustrative of the present invention, but are not meant to limit or otherwise define its scope. All parts, percentages and ratios used herein are expressed as percent weight unless otherwise specified.

### EXAMPLE I

Powder heavy duty detergent in accordance with present invention is prepared as follows:

| | A (ppm) | B (ppm) | C (ppm) |
|---|---|---|---|
| Surfactant | | | |
| Na LAS | 384 | 300 | 222 |
| Na AS | 96 | 120 | 182 |
| Nonionic | 18 | 16 | 15 |
| Builder | 902 | 800 | 702 |
| Aluminosilicate | | | |
| Chelant | 13 | 13 | 17 |
| DTPA | | | |
| Brightener | 4.5 | 45 | 6.8 |
| Br-64 | | | |
| Bleach | 28/37 | 28/37 | 92/65 |
| NOBS/(PB1 or Percarbonate) | | | |
| Fabric Integrity/Dye Transfer | | | |
| Yarn Strength Enhancing Agent | 15 | 45 | 60 |
| PVNO | 5.3 | 5 | 5.3 |
| PVPVI | 5.3 | 5 | 5.3 |
| Enzyme | | 1 | |
| Suds Suppressor | 22 | | 27 |

While particular embodiments of the subject invention have been described, it will be obvious to those skilled in the art that various changes and modifications of the subject invention can be made without departing from the spirit and scope of the invention. It is intended to cover, in the appended claims, all such modifications that are within the scope of the invention.

The compositions of the present invention can be suitably prepared by any process chosen by the formulator, non-limiting examples of which are described in U.S. Pat. No. 5,691,297 Nassano et al., issued Nov. 11, 1997; U.S. Pat. No. 5,574,005 Welch et al., issued Nov. 12, 1996; U.S. Pat. No. 5,569,645 Dinniwell et al., issued Oct. 29, 1996; U.S. Pat. No. 5,565,422 Del Greco et al., issued Oct. 15, 1996; U.S. Pat. No. 5,516,448 Capeci et al., issued May 14, 1996; U.S. Pat. No. 5,489,392 Capeci et al., issued Feb. 6, 1996; U.S. Pat. No. 5,486,303 Capeci et al., issued Jan. 23, 1996 all of which are incorporated herein by reference.

In addition to the above embodiments, the activated enzymes of the present invention can be formulated into any suitable detergent composition, non-limiting examples of which are described in U.S. Pat. No. 5,679,630 Baeck et al., issued Oct. 21, 1997; U.S. Pat. No. 5,565,145 Watson et al., issued Oct. 15, 1996; U.S. Pat. No. 5,478,489 Fredj et al., issued Dec. 26, 1995; U.S. Pat. No. 5,470,507 Fredj et al., issued Nov. 28, 1995; U.S. Pat. No. 5,466,802 Panandiker et al., issued Nov. 14, 1995; U.S. Pat. No. 5,460,752 Fredj et al., issued Oct. 24, 1995; U.S. Pat. No. 5,458,810 Fredj et al., issued Oct. 17, 1995; U.S. Pat. No. 5,458,809 Fredj et al., issued Oct. 17, 1995; U.S. Pat. No. 5,288,431 Huber et al., issued Feb. 22, 1994 all of which are incorporated herein by reference.

Having described the present invention in detail with reference to preferred embodiments, it will be clear to those skilled in the art that various changes and modifications may be made without departing from the scope of the invention, and the invention is not to be considered limited to what is described in the specification.

What is claimed is:

1. A method for treating a fabric in need of treatment comprising contacting the fabric with a yarn strength enhancing agent that satisfies the Test Proctol as described herein.

2. The method according to claim 1 wherein said yarn strength enhancing agent is selected from the group consisting of: polysaccharides, clays, starches, chitosans, and mixtures thereof.

3. A laundry and/or fabric care composition comprising a yarn strength enhancing agent that satisfies the Test Protocol as described herein.

4. The fabric care composition according to claim 3 further comprising one or more adjunct materials.

5. The laundry and/or fabric care composition according to claim 4 wherein said composition further comprises one or more of the following adjunct materials selected from the group consisting of: surfactants, solvents, buffers, enzymes, soil release agents, clay soil removal agents, dispersing agents, brighteners, suds suppressors, fabric softeners, suds organic catalysts, enzyme stabilizers, builders, chelants, other bleaching agents, including metal catalysts, other organic catalysts, dyes, dye transfer inhibiting agents, perfumes and mixtures thereof.

6. A laundry and/or fabric care composition comprising
(a) a yarn strength enhancing agent that satisfies the Test Protocol as described herein; and
(b) a surfactant.

7. A product comprising a yarn strength enhancing agent, the product further including instructions for using the yarn strength enhancing agent to treat a fabric in need of cleaning, the instructions including the step of contacting the fabric with a wash solution comprising the product, wherein the yarn strength enhancing agent satisfies the Test Protocol as described herein.

8. The product according to claim 7 wherein the product is a laundry detergent.

9. The product according to claim 7 wherein the product is a laundry additive.

10. The product according to claim 7 wherein the product is a fabric care composition.

11. A yarn strenghthened article made by the method according to claim 1.
